(19) United States
(12) Patent Application Publication
(10) Pub. No.: US 2004/0203707 A1
(43) Pub. Date: Oct. 14, 2004

(54) Mobile subscriber station operable in a plurality of universal mobile telephone systems

(76) Inventors: A. Akhteruzzaman, Naperville, IL (US); Claudis L. Young, Aurora, IL (US)

Correspondence Address: PATTON BOGGS, 1660 LINCOLN ST, SUITE 2050, DENVER, CO, 80264, US

(21) Appl. No.: 10/233,025

(22) Filed: Aug. 31, 2002

(51) Int. Cl. H04Q 7/20

(52) U.S. Cl. 455/422.1; 455/445; 455/432.1

(57) ABSTRACT

The universal UMTS telephone automatically transitions among the plurality of standards implemented by Universal Mobile Telephone Systems as a function of the present location of the universal UMTS telephone. The subscriber therefore can use the universal UMTS telephone in all locations for uninterrupted wireless communications services. A digital signal processor included in the universal UMTS telephone functions to detect the signaling transmitted by the serving Universal Mobile Telephone System. The digital signal processor loads a particular software module that corresponds to the standard that is implemented by the serving Universal Mobile Telephone System and enables the universal set of communication hardware to process the voice and data signals that are transmitted between the subscriber and the serving Universal Mobile Telephone System.

### FIELD OF THE INVENTION

This invention relates to cellular communications and, in particular, to a mobile subscriber station that provides wireless telephone services in a plurality of Universal Mobile Telephone Systems, which operate using different communications standards.

### PROBLEM

It is a problem in the field of cellular mobile telephone services to provide customers with high quality communication services in a unified manner via a wireless communication medium. Existing Universal Mobile Telephone Systems serve a class of mobile subscriber stations that are equipped with a User Identity Module (UIM) that corresponds to the communication standard that is implemented by the serving Universal Mobile Telephone System, but this service is traditionally not extensible to mobile subscriber stations that are architected to operate in a Universal Mobile Telephone System that implements a different standard.

The existing mobile subscriber stations are incapable of being used in Universal Mobile Telephone Systems that implement a different communication standard. Therefore, subscribers must presently either use one mobile subscriber station for each Universal Mobile Telephone System standard or change the User Identity Module (UIM) to correspond to the communication standard that is implemented by the serving Universal Mobile Telephone System. Many mobile subscriber stations are not designed to enable the replacement of the User Identity Module (UIM) and the subscriber cannot receive service when they are located in a region that implements a communication standard that is incompatible with their mobile subscriber station.

One system that addresses this problem is disclosed in U.S. Pat. No. 6,408,180, wherein a ubiquitous mobile subscriber station extends the usage of existing cellular mobile telecommunication frequencies allocated for ground-based cellular communications to non-terrestrial cellular communications in a manner that avoids the possibility of signal interference between the ground-based and non-terrestrial mobile subscriber stations. In particular, the ubiquitous mobile subscriber station automatically transitions between the communications paradigm used in ground-based cellular communications and the communications paradigm used in non-terrestrial cellular communications as a function of the present location of the ubiquitous mobile subscriber station. The subscriber therefore can use the ubiquitous mobile subscriber station in all locations for uninterrupted wireless communications services. To achieve the automatic transition, the ubiquitous mobile subscriber station is equipped with both a non-terrestrial mobile subscriber station radio apparatus as well as a ground-based mobile subscriber station radio apparatus. The ubiquitous mobile subscriber station can switch between the non-terrestrial and ground-based cellular telephone systems in response to the pilot's activation of the aircraft landing gear, or the “weight on wheels” condition when the aircraft touches down as indicated by the aircraft attitude determining apparatus, or its altitude, above the ground level as determined by the mobile unit location apparatus.

However, there is presently no mobile subscriber station or cellular mobile telephone system that uses a universal set of communication hardware which enables the subscriber to receive wireless cellular mobile telephone services in a unified manner regardless of the signal protocol implemented by the serving Universal Mobile Telephone System. The need for multiple sets of communication hardware to account for non-terrestrial and ground-based cellular telephone systems is an inapplicable solution to the plurality of standards implemented by the Universal Mobile Telephone Systems.

### SOLUTION

The above described problems are solved and a technical advance achieved in the field by the mobile subscriber station operable in a plurality of universal mobile telephone systems of the present invention (termed “universal UMTS telephone” herein) which enables the subscriber to receive wireless cellular mobile telephone services in a unified manner in the plurality of standards implemented by Universal Mobile Telephone Systems. The universal UMTS telephone is equipped with a universal set of communication hardware that performs the basic communication functions as well as a digital signal processor that automatically transitions among the plurality of standards implemented by Universal Mobile Telephone Systems as a function of the present location of the universal UMTS telephone. The subscriber therefore can use the universal UMTS telephone in all locations for uninterrupted wireless communications services.

This is accomplished by the use of a memory located in the universal UMTS telephone which contains a plurality of software modules, each of which defines a one of the plurality of standards that are implemented by Universal Mobile Telephone Systems. A digital signal processor is included in the universal UMTS telephone and functions to detect the signaling transmitted by the serving Universal Mobile Telephone System. The digital signal processor then loads the particular software module that corresponds to the standard that is implemented by the serving Universal Mobile Telephone System and enables the universal set of communication hardware to process the voice and data signals that are transmitted between the subscriber and the serving Universal Mobile Telephone System. In this manner, the third generation (3G) Universal Mobile Telephone Systems, as specified by the 3GPP—WCDMA (Wideband Code Division Multiple Access) which is a Global Systems for Mobile telephones based standard, 3GPP2—CDMA2000 which is an ANSI-195 based standard, UWC-136 (Universal Wireless Communication) which is an ANSI-1 36 based standard, HDR (High Data Rate or 1xEV-DO) and the like are supported by the universal UMTS telephone. Additional systems can be served by simply adding a software module that corresponds to the standard implemented by the new system.

### BRIEF DESCRIPTION OF THE DRAWINGS

FIG. 1 illustrates, in block diagram form, the overall architecture of a typical third generation (3G) Universal Mobile Telephone System;

FIG. 2 illustrates, in block diagram form, the architecture of a typical embodiment of the universal UMTS telephone of the present invention; and

FIG. 3 illustrates, in flow diagram form, the operation of a typical embodiment of the universal UMTS telephone of the present invention.

### DETAILED DESCRIPTION

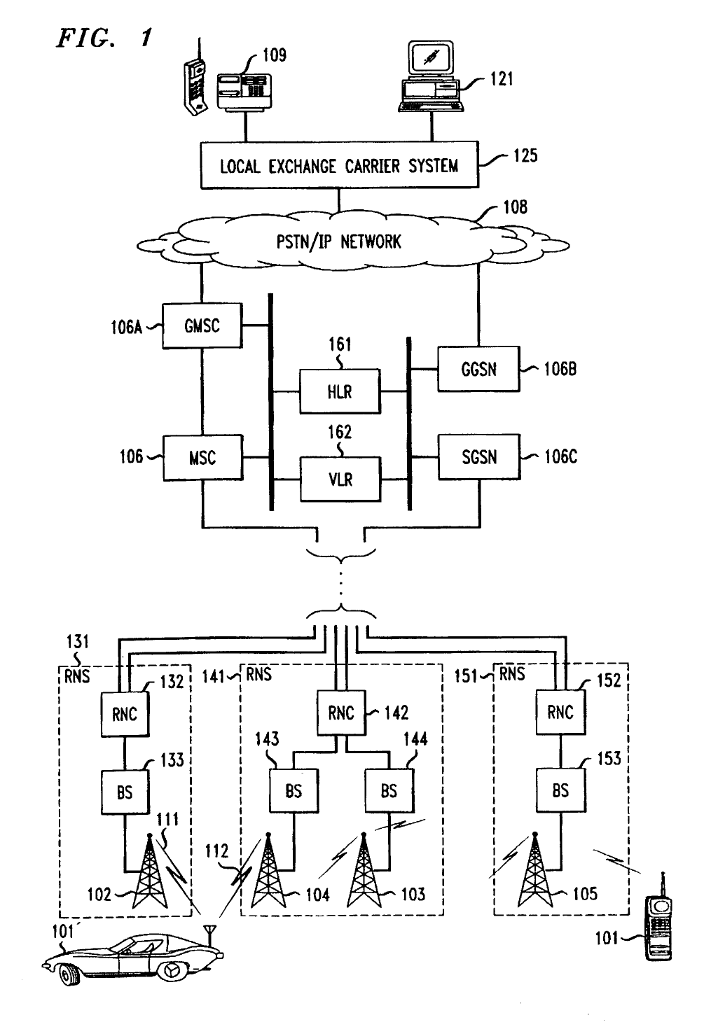

An example of a typical cellular communication network, as shown in block diagram form in FIG. 1, provides the service of connecting wireless telephone customers, each having a mobile subscriber station, to both land-based customers who are served by the common Carrier Public Switched Telephone Network (PSTN) 108 as well as other wireless telephone customers. In such a network, all incoming and outgoing calls are routed through Mobile Switching Centers (MSC) 106, each of which is connected to a plurality of Radio Network Subsystems (RNS) 131-151 which communicate with mobile subscriber stations 101, 101′ located in the area covered by the cell sites. The standard implemented by a particular Universal Mobile Telephone System, while a function of the present location of the universal UMTS telephone, do not vary over wide geographic areas, since the serving vendor typically manages a service area that is very large in extent. The mobile subscriber stations 101, 101′ are served by the Radio Network Subsystems (RNS) 131-151, each of which is located in one cell area of a larger service region. Each cell site in the service region is connected by a group of communication links to, the Mobile Switching Center 106. Each cell site contains a group of radio transmitters and receivers, termed a “Base Station” herein, with each transmitter-receiver pair being connected to one communication link. Each transmitter-receiver pair operates on a pair of radio frequencies to create a communication channel: one frequency to transmit radio signals to the mobile subscriber station and the other frequency to receive radio signals from the mobile subscriber station.

The Mobile Switching Center 106, in conjunction with the Home Location Register (HLR) 161 and the Visitor Location Register (VLR) 162, manages subscriber registration, subscriber authentication, and the provision of wireless services such as voice mail, call forwarding, roaming validation and so on. The Mobile Switching Center 106 is connected to a Gateway Mobile Services Switching Center (GMSC) 106A as well as to the Radio Network Controllers, with the GMSC 106A serving to interconnect the MSC 106 with the PSTN/IP Network 108. In addition, the Radio Network Controllers are connected via Serving GPRS Support Node 106C and thence the Gateway GPRS Support Node GGSN 106B to the Internet. The Radio Network Controllers 132, 142, 152 at each cell site Radio Network Subsystem 131-151 control the transmitter-receiver pairs at the Radio Network Subsystem 131. The control processes at each Radio Network Subsystem also control the tuning of the mobile subscriber stations to the selected radio frequencies. In the case of WCDMA, the system also selects the PN code word to enhance isolation of the communications with the mobile subscriber stations.

The WCDMA platform operates as a Code Division Multiple Access wireless network in a Wideband format (the “W” in WCDMA) and is designed to carry a wireless call between a mobile subscriber station and a Base Station, by simultaneously using multiple Base Stations or antennas to mitigate the effects of signal fading of various types. If one cell or one antenna in the WCDMA cellular network has a poor signal for a given time frame, another cell or antenna in the WCDMA cellular network which had an acceptable signal carries the call. This call management process is called soft or softer hand-off, depending on whether the call is carried between two cells or two antennas at a given cell, respectively. The RF carriers are 4.4 to 5.0 MHz wide in the spectral domain with each RF carrier supporting multiple simultaneous “dedicated channels” subdivided in the code domain. Since WCDMA is wideband, it's chip rate is 3.84 Mcps, which is over three times that of IS-95's chip rate.

In FIG. 1, the mobile subscriber station 101 is simultaneously communicating with two Base Stations 133 & 143, thus constituting a soft handoff. However, a soft handoff is not limited to a maximum of two Base Stations. When in a soft handoff, the Base Stations serving a given call must act in concert so that commands issued over RF channels 111 and 1 12 are consistent with each other. In order to accomplish this consistency, one of the serving Base Stations may operate as the primary Base Station with respect to the other serving Base Stations. Of course, a mobile subscriber station 101 may communicate with only a single Base Station if this is determined to be sufficient by the cellular communication network.

The control channels that are available in this system are used to setup the communication connections between the mobile subscriber stations 101 and the Base Station 133. When a call is initiated, the control channel is used to communicate between the mobile subscriber station 101 involved in the call and the local serving Base Station 133. The control messages locate and identify the mobile subscriber station 101, determine the dialed number, and identify an available voice/data communication channel consisting of a pair of radio frequencies and orthogonal coding which is selected by the Base Station 133 for the communication connection. The radio unit in the mobile subscriber station 101 re-tunes the transmitter-receiver equipment contained therein to use these designated radio frequencies and orthogonal coding. Once the communication connection is established, the control messages are typically transmitted to adjust transmitter power and/or to change the transmission channel when required to handoff this mobile subscriber station 101 to an adjacent cell, when the subscriber moves from the present cell to one of the adjoining cells. The transmitter power of the mobile subscriber station 101 is regulated since the magnitude of the signal received at the Base Station 133 is a function of the mobile subscriber station transmitter power and the distance from the Base Station 133. Therefore, by scaling the transmitter power to correspond to the distance from the Base Station 133, the received signal magnitude can be maintained within a predetermined range of values to ensure accurate signal reception without interfering with other transmissions in the cell.

The voice communications between mobile subscriber station 101 and other subscriber stations, such as land line based subscriber station 109, is effected by routing the communications received from the mobile subscriber station 101 through the Telephone Switching Center 106 and trunks to the Public Switched Telephone Network (PSTN) 108 where the communications are routed toga Local Exchange Carrier 125 that serves land line based subscriber station 109. There are numerous Mobile Switching Centers 106 that are connected to the Public Switched Telephone Network (PSTN) 108 to thereby enable subscribers at both land line based subscriber stations and mobile subscriber stations to communicate between selected stations thereof. This architecture represents the present architecture of the wireless and wireline communication networks.

### Wideband Code Division Multiple Access

The Wideband Code Division Multiple Access (WCDMA) platform is a typical third generation cellular standard and is used herein to illustrate the operation of the universal UMTS telephone. The Wideband Code Division Multiple Access network operates as a Code Division Multiple Access wireless network in a Wideband format (the “W” in WCDMA). The RF carriers are 4.4 to 5.0 MHz wide in the spectral domain with each RF carrier supporting multiple simultaneous “channels” subdivided in the code domain. The data streams are spread using code words which enables processing gain at the receiver thereby improving the quality of reception both in terms of BLER/BER (Block Error Rate and Bit Error Rate) and overall improvement in signal levels with respect to noise and interference (Ec/Io). The receiver accomplishes this “process gain” through the use of up to eight (formerly four with IS-95) Rake receivers, all operating on different code words on the same frequency of reception. WCDMA, like the CDMA2000 family and IS-95, uses Dynamic Power Control (DPC) to manage self-inference generated by users communicating on the same frequency. WCDMA has both forward and reverse path fast Dynamic Power Control at 1500 Hz (while IS-95 is at 800 Hz in the reverse path only).

Handovers, or handoffs, are managed by network equipment directly connected to the Base Stations. In WCDMA, this equipment is called a Radio Network Controller (RNC) versus a Base Station Controller (BSC) in IS-95. Despite the name change, the devices perform similar functions. The 5 MHz carrier creates an environment for improved multi-path fading resistance due to the broadband nature of the carrier. Selective frequency fades at any given frequency or narrowband of frequencies do not occur at the same time and the matched filter reception processor does not “see” these deep frequency selective fades. Unlike the CDMA2000 family, the transmissions in WCDMA, while circuit switched in nature, are packetized into 10 millisecond frames for the over-the-air interface. These frames contain multiple, simultaneous code-divided channels called Dedicated Channels (DCHs) and associated network signaling control channels such as Forward Access Channel (FACH), Reverse Access Channel (RACH) and so on. The Dedicated Channel is the primary bearer of traffic or content to/from the mobile subscriber station 101 to the Base Station 133. Within each frame, the bit rate is variable for any given user channel and is managed by the network to optimize delivery of traffic/content in a spectrally efficient manner. So, for example, Dedicated Channel One on Frame One may have a low bit rate (relative) but on Frame Two, Dedicated Channel One may change to a high bit rate (again relative). This process is done for each frame, on a frame-by-frame basis and incorporates the traffic profile of each code divided channel. In addition, the network manages the addition and deletion of channels as traffic is added or terminated (again, in the code domain). In addition to managing the bit rates per code divided channel on a 10 millisecond time domain basis, the code word spreading on a Dedicated Channel basis is variable based on the class of service being offered. This process essentially reallocates bandwidth by increasing or decreasing the length of the spreading sequence thereby creating network defined Classes of Service. These classes are:

| | |
|---|---|
| Conversational- | Voice, video telephony (very low latency) |
| Streaming- | Multimedia (preserve internal time relationship) |
| Interactive- | Web browsing, games (preserve data integrity) |
| Background- | E-mail (time insensitive, preserve data integrity) |

These are termed Quality of Service (QoS) and the frame error rates can vary from a 10% frame error rate to 10⁻⁶ bit error rate. The lower the bit error rate, the higher the spreading sequence meaning more transmit power and bandwidth are used with a corresponding higher Quality of Service. From the mobile subscriber station's perspective, the Quality of Service and occupied base-band data rate affect the final encoded data rate on a frame-by-frame basis, the call appears, in its functionality, to be circuit switched and continuous in nature. This is particularly true when in soft or softer handoff. While occupying differing levels of power on a frame-by-frame basis with a modulated bit rate determined by the base-band bit rate (which may change frame-by-frame as the traffic load changes) times the spreading rate (which determines Quality of Service and power used), any given call having its own Dedicated Channel can operate in soft/softer handoff as if it were purely circuit switched.

### Universal UMTS Telephone

In this environment, the universal UMTS telephone (U-UMTS) enables the subscriber to receive wireless cellular mobile telephone services in a unified manner by automatically transitioning among the plurality of standards implemented by Universal Mobile Telephone Systems as a function of the present location of the universal UMTS telephone U-UMTS. The subscriber who is equipped with a universal UMTS telephone U-UMTS can maintain a single set of identification data (MIN, ESN) regardless of their location in the cellular mobile telephone network and independent of the mode of operation. Thus, the subscriber can receive service regardless of their present location and the nature of the Universal Mobile Telephone System that serves their present location.

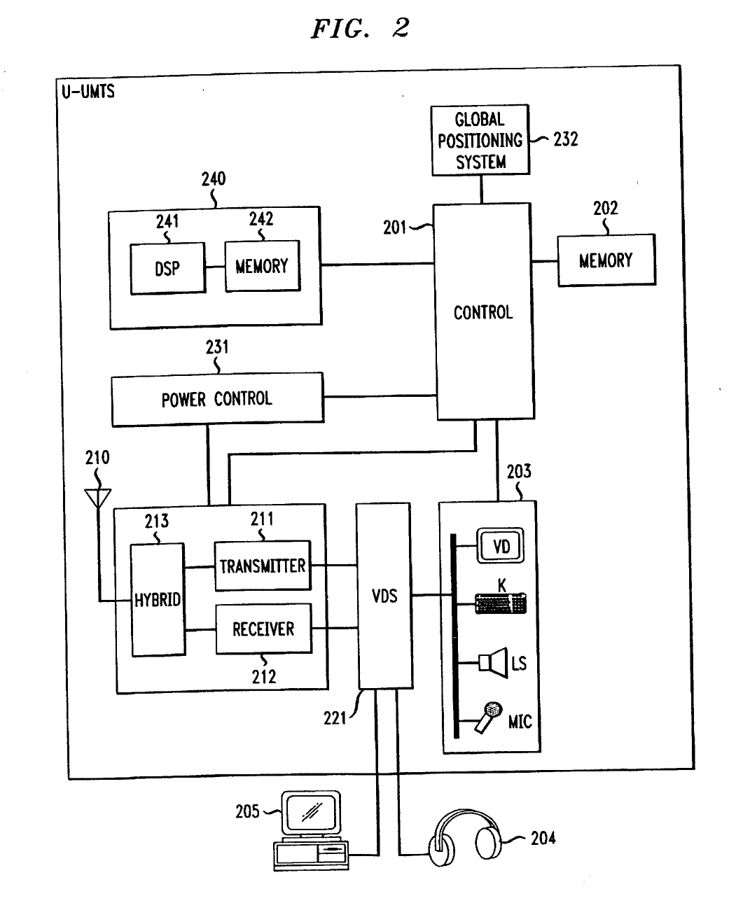

FIG. 2 illustrates, in block diagram form, the architecture of a typical embodiment of the universal UMTS telephone U-UMTS of the present invention. This particular embodiment of the universal UMTS telephone U-UMTS is disclosed to illustrate the concepts of the invention and is not intended to limit the application of the disclosed concepts. The universal UMTS telephone U-UMTS is equipped with a processor 201 that operates pursuant to instructions that are stored in memory 202, as is described below. In this particular application, the universal UMTS telephone U-UMTS can also contain mobile unit location apparatus, such as global positioning system 232, to produce an indication of the location of the universal UMTS telephone U-UMTS.

The universal UMTS telephone U-UMTS is equipped with transmitter 211 and receiver 212 circuits well known in cellular communications for providing voice and data communications via a voice data switch 221. The apparatus also includes antenna 210, which is typically mounted on an exterior surface of the universal UMTS telephone U-UMTS and coupled in well-known fashion to the transmitter 211 and receiver 212 circuits by a hybrid 213. The power output of the transmitter 211 can also be dynamically regulated as a function of the distance from the cell site transmitter antenna to ensure a relatively constant signal level, using the Power Control circuit 231 presently available in many cellular radio systems.

The universal UMTS telephone U-UMTS includes a user interface 203 that is equipped with the apparatus necessary to enable the user to receive and input data. For example, the user interface NTR includes a display device VD that produces a human sensible visualization of the data that is received and audio output device LS to produce a human sensible audio output of the received data. The user interface can also include audio input devices MIC and keyboard K (and/or mouse or pointer device) to enable the user to input data in an audible or textual form, respectively. In addition, the universal UMTS telephone U-UMTS can be connected to a headset 204, computing device 205 or other such apparatus, to enable the subscriber to use these ancillary devices for communication purposes.

The above-described elements are used in mobile subscriber stations and represent a universal set of communication hardware that performs the basic communication functions for exchanging data between said subscriber and said cell site of a cellular communication system. The protocols used in the processing of the communication signals received by the mobile subscriber station over the radio channel from the cell site and transmitted from the mobile subscriber station to the cell site, varies as a function of the Universal Mobile Telephone System that presently serves the mobile subscriber station.

In addition, in some applications, a portion of the radio frequency circuitry also represents a common element. For example, 1xEV systems are designed to be highly interoperable with CDMA systems. Leveraging from the same RF characteristics as IS-95/1x CDMA, dual mode IS-95/1x and 1xEV access terminals can be offered in a compact and efficient manner. Within a given network, dual mode IS-95/1x and 1xEV devices allow users to access voice services via the IS-95/1x frequency carrier, while receiving data services through the 1xEV frequency carrier. Therefore, while 1xEV requires a separate CDMA channel, 1xEV maintains 100% b compatibility with IS-95/1x from the RF standpoint.

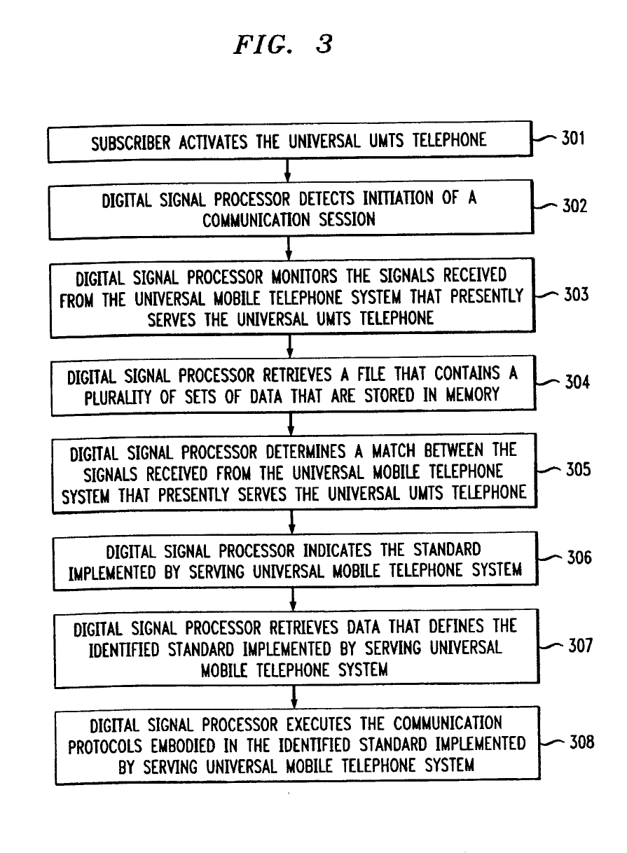

The traditional mobile subscriber station contains a device called a USIM or User Subscriber Identity Module. The USIM is a device that is physically located in the mobile subscriber station but can be removable in nature. The USIM contains all relevant subscriber information, including information that is important for billing purposes. The universal UMTS telephone U-UMTS includes a Subscriber Module 240 that includes the basic billing functions that are provided by a USIM, but also includes, for the sake of illustration, a digital signal processor 241 and an optional memory 242 that function to interface with the plurality of standards implemented by Universal Mobile Telephone Systems. FIG. 3 illustrates, in flow diagram form, the operation of a typical embodiment of the universal UMTS telephone of the present invention. In operation, the digital signal processor 241 detects the initiation of a communication session with the Universal Mobile Telephone System that presently serves the universal UMTS telephone U-UMTS. This is accomplished by the digital signal processor 241 detecting at step 302 the activation of the universal UMTS telephone U-UMTS by the subscriber at step 301. In well-known fashion, the activation of the universal UMTS telephone U-UMTS includes a set of interactions with the Universal Mobile Telephone System that presently serves the universal UMTS telephone U-UMTS to identify the presence of the universal UMTS telephone U-UMTS. The digital signal processor 241 at step 303 monitors the signals received from the Universal Mobile Telephone System that presently serves the universal UMTS telephone U-UMTS typically as present in receiver 211. At step 304, the digital signal processor 241 retrieves a file that contains a plurality of sets of data that are stored either in memory 242 or memory 202, with each set of data in the file being indicative of the signaling used by a one of the plurality of standards implemented by Universal Mobile Telephone Systems. The signaling typically varies by system and the file would therefore typically include data regarding a selected set of third generation (3G) Universal Mobile Telephone Systems, such as those specified by the 3GPP—WCDMA (Wideband Code Division Multiple Access) which is a Global Systems for Mobile telephones based standard, 3GPP2—CDMA2000 which is an ANSI-195 based standard, UWC-136 (Universal Wireless Communication) which is an ANSI-136 based standard, HDR (High Data Rate or 1xEV-DO) and the like. At step 305, the digital signal processor 241 determines a match between the signals received from the Universal Mobile Telephone System that presently serves the universal UMTS telephone U-UMTS and a one of the plurality of sets of data and at step 306 indicates the standard implemented by serving Universal Mobile Telephone System. The digital signal processor 241 at step 307 retrieves data, stored either in memory 242 or memory 202, that defines the identified standard implemented by serving Universal Mobile Telephone System. At step 308, the digital signal processor 241 and/or the processor 201 execute the communication protocols embodied in the identified standard implemented by serving Universal Mobile Telephone System to thereby enable the universal set of communication hardware to process the voice and data signals that are transmitted between the subscriber and the serving Universal Mobile Telephone System.

### Summary

The universal UMTS telephone automatically transitions among the plurality of standards implemented by Universal Mobile Telephone Systems as a function of the present location of the universal UMTS telephone. The subscriber therefore can use the universal UMTS telephone in all locations for uninterrupted wireless communications services.

What is claimed:

1. A mobile subscriber station, operable to execute a selected one of a plurality of different cellular communication standards to enable a subscriber to exchange data with a cell site of a cellular communication system, comprising:
memory means for storing a plurality of program files, each of which represents a predetermined protocol conversion usable to format data into a predefined protocol for use by said subscriber and said cell site of a cellular communication system in a manner defined by a corresponding to said one of said plurality of different cellular communication standards;
transmitter/receiver means for communicating via radio frequency communication signals with a cell site of a cellular communication system;
means for converting between said radio frequency communication signals and subscriber data to exchange data between said subscriber and said cell site of a cellular communication system, using a one of said plurality of different cellular communication standards, comprising:
means, responsive to receipt of radio frequency communication signals from said cell site, for determining which one of said plurality of different cellular communication standards corresponds to said received radio frequency communication signals,
means, responsive to said means for determining, for selecting a one of said plurality of program files corresponding to said one of said plurality of different cellular communication standards, and
cellular communications protocol converter means to execute said selected one of said plurality of program files to implement said one of said plurality of different cellular communication standards in the exchange of data between said subscriber and said cell site of a cellular communication system.

2. The mobile subscriber station of claim 1 further comprising:
communication means for performing the basic communication functions to exchange data between said subscriber and said cell site of a cellular communication system.

3. The mobile subscriber station of claim 1 wherein said means for converting further comprises:
digital signal processor means for automatically transitions among said plurality of different cellular communication standards.

4. The mobile subscriber station of claim 1 wherein said means for converting further comprises:
means for detecting the activation of the mobile subscriber station by the subscriber; and
means, responsive to said means for detecting, for activating said means for determining.

5. A method of operating a mobile subscriber station, operable to execute a selected one of a plurality of different cellular communication standards to enable a subscriber to exchange data with a cell site of a cellular communication system, comprising:
storing in a memory a plurality of program files, each of which represents a predetermined protocol conversion usable to format data into a predefined protocol for use by said subscriber and said cell site of a cellular communication system in a manner defined by a corresponding to said one of said plurality of different cellular communication standards;
communicating via radio frequency communication signals with a cell site of a cellular communication system;
converting between said radio frequency communication signals and subscriber data to exchange data between said subscriber and said cell site of a cellular communication system, using a one of said plurality of different cellular communication standards, comprising:
determining, in response to receipt of radio frequency communication signals from said cell site, which one of said plurality of different cellular communication standards corresponds to said received radio frequency communication signals,
selecting, in response to said step of determining, a one of said plurality of program files corresponding to said one of said plurality of different cellular communication standards, and
executing said selected one of said plurality of program files to implement said one of said plurality of different cellular communication standards in the exchange of data between said subscriber and said cell site of a cellular communication system.

6. The method of operating a mobile subscriber station of claim 5 further comprising:
performing the basic communication functions to exchange data between said subscriber and said cell site of a cellular communication system.

7. The method of operating a mobile subscriber station of claim 5 wherein said step of converting further comprises:
automatically transitioning among said plurality of different cellular communication standards.

8. The method of operating a mobile subscriber station of claim 5 wherein said step of converting further comprises:
detecting the activation of the mobile subscriber station by the subscriber; and
activating, in response to said step of detecting, said step of determining.
